(19) United States
(12) Patent Application Publication
(10) Pub. No.: US 2004/0122984 A1
(43) Pub. Date: Jun. 24, 2004

(54) Data processor and data table update method

(76) Inventors: Hidemi Oyama, Chitose (JP); Katsumi Iwata, Kodaira (JP); Yoshikazu Iida, Higashimurayama (JP); Shinichi Fukasawa, Kodaira (JP); Tsukasa Fujimoto, Mizuho (JP)

Correspondence Address: MILES & STOCKBRIDGE PC, 1751 PINNACLE DRIVE, SUITE 500, MCLEAN, VA, 22102-3833, US

(21) Appl. No.: 10/477,400

(22) PCT Filed: May 9, 2002
(86) PCT No.: PCT/JP02/04527

(30) Foreign Application Priority Data
May 14, 2001 (JP) 2001-142499

(51) Int. Cl. G06F 3/00

(52) U.S. Cl. 710/1

(57) ABSTRACT

An interface controller is designed to separately define the first control information to be supplied to the first latch means for controlling an operation of an interface-controlled device connected to the same controller and the second control information to be supplied to the second latch means for controlling an interface operation with the interface-controlled device, in a form of a pair of the first and second information. When there is an addition or a change in a command defined for the interface-controlled device, as for a command transmission to the interface-controlled device and as for an interface control operation of the interface controller itself, both the control information can be independently amended to cope with the addition or the change.

### BACKGROUND OF THE INVENTION

The present invention relates to a data processor including an interface controller for interfacing and controlling a peripheral device such as a multimedia card (MMC card), a security digital card (SD card), a flash memory card, and an AT attachment card (ATA card), and more particularly to the technique for coping with a specification change of a control command and addition of a control command to the peripheral device that is the interface-controlled device, and for example, to the technique effective when it is adopted to an interface controller of the MMC card and further a data processor of single chip having the above. Here, the MMC is the registered trademark.

Various peripheral devices including a small-sized nonvolatile storage device represented by the MMC card are used for a personal computer (PC) and a portable terminal. An interface controller interfacing with such peripheral device so to control has to be provided with a function of signal input/output control which satisfies the interface specification of the peripheral device. For example, in the case of a multimedia card, terminal function, operation voltage, command specification, and data format are previously determined. For example, the specification is determined as follows: for example, the MMC card has an SPI mode and an MMC mode, the command is formed by a command portion, an argument portion, and a CRC portion, a response is returned when a predetermined command is issued to the multimedia card, and so on.

As an example of the article described about the MMC card, there is the Interface published by CQ publisher Co. Ltd. (in December, 1999) p. 124 to p. 130.

### SUMMARY OF THE INVENTION

The present inventor examines the method in which an interface controller interfacing with the peripheral device such as the MMC card in order to control satisfies the interface specification of the peripheral device. In order to satisfy the interface specification, it is necessary to realize a control function for controlling the interface with the peripheral device operating by the command, according to the command specification of the peripheral device, and for example, the command to be given to the peripheral device is decoded, hence to execute the necessary processing on the side of the interface controller. When adopting the control logic fully depending on the above hard wired logic, however, it is found that it is not easy to cope with a change of the command specification and an addition of the command. Especially, when the addition of a user-unique command is guaranteed on the specification, it is too useless to cope with all the possible commands and it is found that it is not realistic.

An object of the invention is to provide a data processor capable of easily coping with the addition and change of the interface specification, represented by the command specification of the interface-controlled device.

Another object of the invention is to provide a data processor capable of coping with the addition and change of the interface specification, represented by the command specification of the interface-controlled device, without increasing the circuit size.

Further, another object of the invention is to provide a method for updating a data table in order to easily cope with the addition and change of the interface specification represented by the command specification of the interface-controlled device.

The above and the other objects and the novel features of the invention will be apparent from the description of this specification and the attached drawings.

[1] The data processor according to the invention has a central processing unit and an interface controller (3) controlled by the central processing unit. The interface controller comprises first latch means (CMDR) for receiving the first control information for controlling an operation of an interface-controlled device (6) connected to the same controller according to a control of the central processing unit and second latch means (MDR, CTR, RTR) for receiving the second control information for controlling an interface operation with the interface-controlled device according to the control of the central processing unit.

In the data processing, when there is an addition or a change in the command defined for the interface-controlled device, naturally the control contents of the interface controller are affected. At this time, as for the command transmission to the interface-controlled device, the added or changed command code may be newly added as one of the first control information or the corresponding first control information may be amended. As for the interface control operation of the interface controller itself, the second control information may be amended so as to control the function or the operation of the interface-controlled device in accordance with the addition or the change by the added or changed command code. Thus, the above data processor can cope with the addition/change of the interface specification more easily than in the case of directly decoding the command to transmit to the interface-controlled device to do an interface control, without increasing the circuit size.

It is preferable that the interface controller comprises control means (9) for transmitting the first control information after the first and second control information is latched by the first and second latch means. The interface operation will be more stable when starting an operation of the interface-controlled device after the contents of the interface control has been determined.

The second control information includes first type specification information for classifying an operation form of the interface-controlled device into a basic form according to the first control information and second type specification information for classifying variations of the classified operation forms. Thus, it is possible to support all the commands that can be defined by a combination of the first type specification information and the second type specification information, and within the above range, it is possible to cope with the addition and the change of the command specification and its method is very clear.

When the interface controller comprises control means (9) for controlling the interface operation after decoding the first and second type specification information, even if the control means is based on a hard wired logic or a program control, it is easy to cope with the situation.

The first type specification information may adopt the information of several bits designating the basic form about the presence of a data transfer, the direction of a data transfer (read, write), and a data transfer sequence.

The second type specification information may adopt the information of several bits specifying the data amount of a command response to a command.

The second control information may include the operation mode information for determining a connection terminal function with the interface-controlled device in a selectable way.

The data processor may further comprise a nonvolatile storing device (5) capable of storing a correspondence relationship between the first control information and the second control information in a way of being referred to by the central processing unit. In order to write the data on the correspondence relationship into the nonvolatile storing device, it is efficient to use a data library with the above correspondence relationship defined previously. Rewriting every change or addition in the command specification would be perfect. Data download from such data library would be more efficient through a network such as the Internet.

The nonvolatile storing device may be a flash memory rewritable through the central processing unit. The data processor may be formed on one semiconductor chip including this flash memory. Naturally, a multi-chip structure may be adopted.

The interface controller controls, for example, a nonvolatile memory card as the interface-controlled device. The nonvolatile memory card is, for example, a multimedia card.

[2] The data processor from another viewpoint has the central processing unit and the interface controller similarly. When the interface controller (3A) comprises the first latch means (30, 31) for receiving the first control information for controlling an operation of an interface-controlled device connected to the above controller according to a control of the central processing unit and the second latch means (34) for receiving the second control information for controlling an interface operation with the interface-controlled device according to a control of the central processing unit, the central processing unit transmits the first control information supplied to the first latch means, to the interface-controlled device, and thereafter sequentially supplies the second control information to the second latch means, hence to sequentially control an interface operation with the interface-controlled device operating according to the first control information. The sequential control of the interface operation depends on the software of the CPU and increases the load of the CPU, but the flexibility of the control operation can be increased. The sequential control is a control form similar to a so-called program control. Thanks to this, it can be easier to cope with the addition/change of the interface specification represented by the command specification of the interface-controlled device similarly to the above, and it can be cope with the addition/change of the interface specification without increasing the circuit size.

[3] A method of updating a data table in order to cope with a change of the command specification of the interface-controlled device is the data table update method in a data processing system having an interface controller and the data table (20, 22) referred to for controlling the interface controller. The interface controller includes the first latch means (CMDR) for receiving the first control information for controlling an operation of the interface-controlled device connected to the above controller and the second latch means (MDR, CTR, RTR) for receiving the second control information for controlling an interface operation with the interface-controlled device. The data table holds a correspondence relationship between the first control information and the second control information in a rewritable way. In accordance with the addition or the change of the first control information, a correspondence between the first control information concerned with the addition and the second control information is added to the data table and a correspondence between the first control information concerned with the change and the second control information is amended in the data table. The data table is, for example, a rewritable nonvolatile storing device (5).

According to the method, when the command specification of the interface-controlled device is changed, it is necessary to use the corresponding second control information. When a new pair of the first control information and the second control information is provided in the data table by using the above data table update method, it takes not so much trouble to cope with the change of the command specification.

### BRIEF DESCRIPTION OF THE DRAWINGS

FIG. 1 is a block diagram showing a first example of a data processor according to the invention.

FIG. 2 is a format view showing an example of the card control command of the MMC card.

FIG. 3 is a view showing an example of a connection state of connecting the MMC card and the MMCIF in the MMC mode.

FIG. 4 is a view showing an example of the connection state of connecting the MMC card and the MMCIF in the SPI mode.

FIG. 5 is a view for use in schematically showing the type of operation according to a card control command in the command operation type information and the command response type information.

FIG. 6 is a timing chart showing an example of an operation sequence of the command transmission and the command response reception classified into the second command format (CMD+RES).

FIG. 7 is a timing chart showing an example of an operation sequence of the command transmission, the command response reception, and the data read access classified into the fourth command format (CMD+RES+Read Data, single).

FIG. 8 is a timing chart showing an example of an operation sequence of the command transmission, the command response reception, and the multiple data read access classified into the fifth command format (CMD +RES +Read Data, multiple).

FIG. 9 is a timing chart showing an example of an operation sequence of the command transmission, the command response reception, and the write access classified into the seventh command format (CMD+RES+Write Data, single).

FIG. 10 is a block diagram showing a second example of a data processor according to the invention.

FIG. 11 is a block diagram showing the data processor on the whole according to the invention.

### DESCRIPTION OF THE PREFERRED EMBODIMENTS

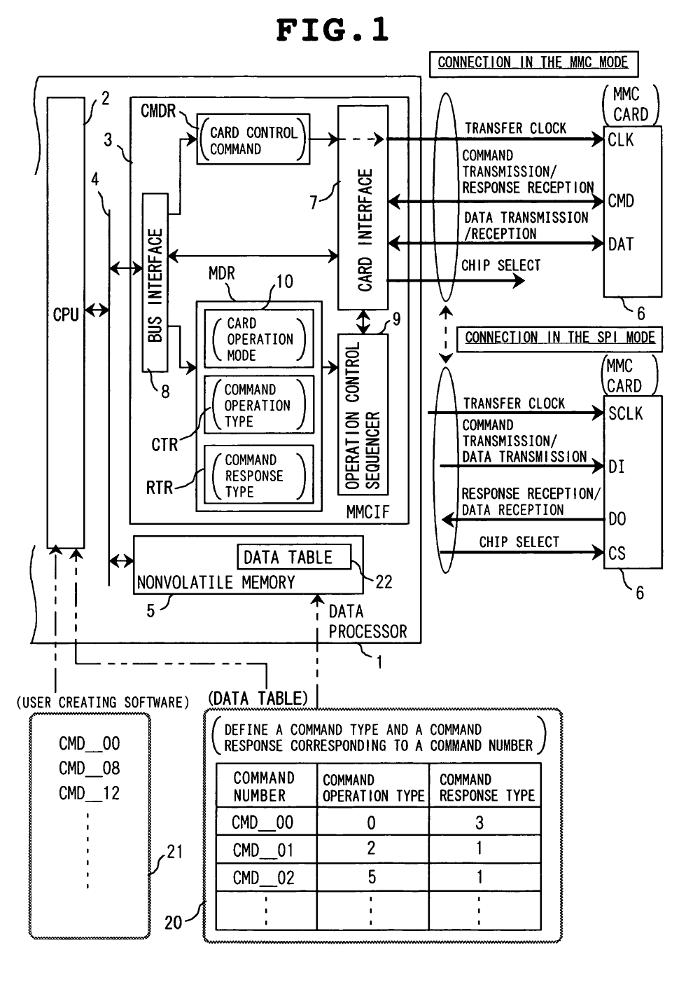

FIG. 1 shows a first example of the data processor according to the invention. A data processor 1 shown in this figure is formed, for example, on one semiconductor substrate (semiconductor chip) like a monocrystal silicon according to the CMOS integrated circuit manufacturing technique.

The data processor 1 comprises a central processing unit (CPU) 2 and an MMC interface controller (MMCIF) 3 as an interface controller controlled by the CPU 2. The CPU 2 and the MMCIF 3 are connected by a bus 4 and a nonvolatile memory 5 like an electrically erasable and writable flash memory is combined with this bus 4.

The MMCIF 3 includes a card interface 7 connected to an MMC card 6 as the interface-controlled device, a bus interface 8, an operation control sequencer 9, and a plurality of registers and buffers. As the registers and the buffers, there are representatively shown, a command register CMDR that is one example of the first latch means, and a mode register MDR, a command type register CTR, and a response type register RTR that are one example of the second latch means 10. Although their illustration is omitted, the second latch means is additionally provided with a command start register, a transfer block counter, and a transfer byte counter. The bus interface 8 is connected to the CPU 2 through the bus 4. The information of the command register CMDR and the second latch means 10 are set through the bus interface 8.

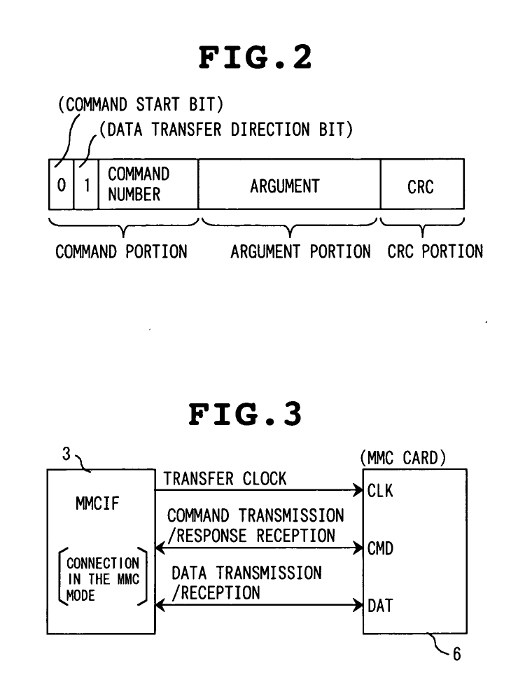

A card control command (first control information) for controlling an operation of the MMC card 6 connected to the MMCIF 3 is given to the command register CMDR from the CPU 2. The card control command set in the command register CMDR is given to the MMC card 6 through the card interface 7 according to a control of the operation control sequencer 9. As illustrated in FIG. 2, the card control command has the data length of 6 bytes including a command portion of one byte, an argument portion of four bytes, and a CRC portion of one byte. At the head of the command portion, there are a command start bit (“0”) and a data transmission direction bit, and the command number as the command index is specified by six bits. The access control information such as access address is stored in the argument portion.

The MMC card 6 performs the operations, for example, of returning the status of the MMC card 6 to the MMCIF 3 as a command response, returning the read data from the MMC card 6 to the MMCIF 3 through read access, and storing the write data from the MMCIF 3 into the MMC card 6, according to the contents of a card control command given from the MMCIF 3. The interface control by the MMCIF 3 of receiving the command response and the read data to be returned as the result of the MMC card 6 operating according to the card control command, or supplying the write data to the MMC card 6, is performed by the operation control sequencer 9 decoding the control information set in the register MDR, CTR, and RTR correspondingly to the card control command.

The basic specification about the command number of the card control command and its corresponding operation and function has been already formulated by the MMC association. The contents are well known and not described in detail here, but a command is defined as for one of the number which can be specified by the above six bits. There is a possibility of adding an extension command in the future as for the vacant number other than the defined one.

In the mode register MDR, the operation mode information for selecting an operation mode for determining a connection terminal function with the MMC card 6 selectively, namely, for selecting the MMC mode or the SPI mode, is set by the CPU 2.

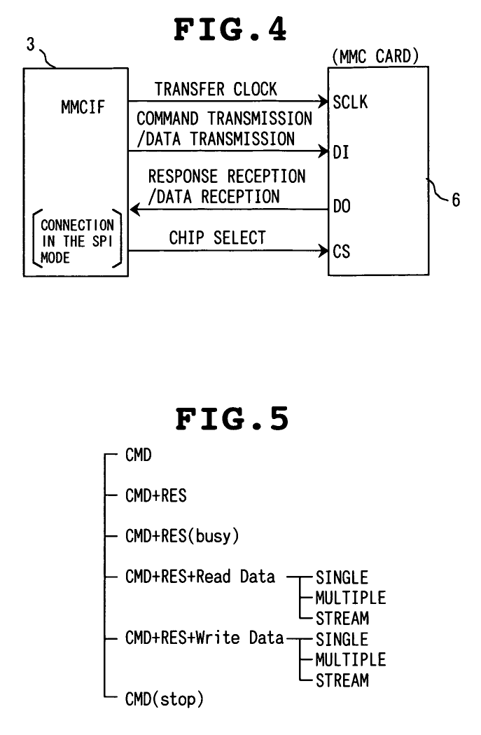

The basic specification including the command of the MMC card 6, the terminal function, and the card size has been formulated already by the MMC association. In this specification, the MMC card 6 has first to seventh external terminals, and in the MMC mode (multimedia card mode), as shown in FIG. 3, the first external terminal not illustrated works as a reserve terminal (open or fixed at logical “1”), the second external terminal works as a command terminal (performing a command input and a response signal output) CMD, the third and the sixth external terminals, not illustrated, work as a grounded voltage (ground) terminal of a circuit, the fourth external terminal, not illustrated, works as a power voltage supply terminal, the fifth external terminal works as a clock input terminal CLK, and the seventh external terminal works as a data input/output terminal DAT. In the SPI (Serial Peripheral Interface) mode, as illustrated in FIG. 4, the first external terminal works as a chip select terminal (negative logic) CS, the second external terminal works as a data input terminal (for data and command input into a card from the host) DI, the third and the sixth external terminals, not illustrated, work as a grounded voltage (ground) terminal of a circuit, the fourth external terminal, not illustrated, works as a power voltage supply terminal, the fifth external terminal works as a clock input terminal CLK, and the seventh external terminal works as a data output terminal (for data and status output from the memory card to the host) DO. The MMC mode is a suitable operation mode for a system using a plurality of MMC cards simultaneously, and each MMC card is identified by the card ID (relative address) the host assigned to each of them. The SPI mode is suitable for use in an easy and inexpensive system, and the MMC card is selected by a chip select signal CS supplied from the host.

In the command type resister CTR, the CPU 2 sets the information for several bits indicating whether the data transfer operation follows the operation specified by the card control command, as the first type specification information (command operation type information) for classifying the operation form of the MMC card 6 into the basic form according to the card control command, the data transfer direction (discrimination between read operation and write operation) when the data transfer operation follows, and the classification of the basic form of the data transfer sequence of the following data transfer operation. Although the basic form of the data transfer sequence is not especially limited, it includes a single data block transfer, a multiple data block transfer, and a stream data transfer.

In the response type register RTR, the CPU 2 sets the information for several bits, for example, for specifying the data amount of the command response to a command, as the second type specification information (command response type information) for classifying variations of the operation forms which have been classified by the command operation type information set in the command type resister CTR. The data amount which can be specified includes 0 byte (requiring no command response), 1 byte, 2 bytes, 5 bytes, 6 bytes, and 17 bytes.

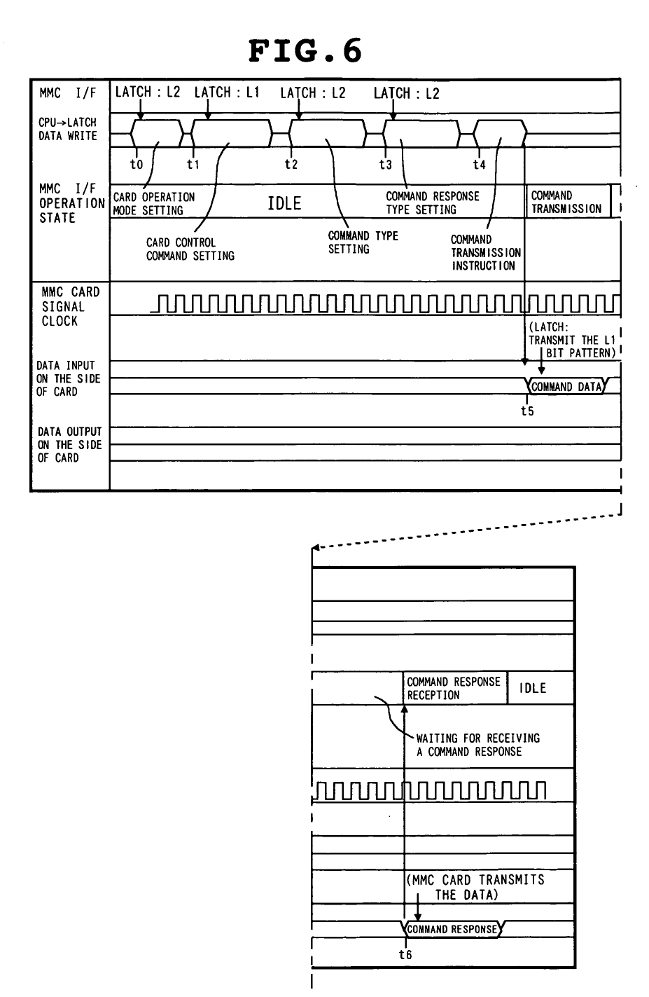

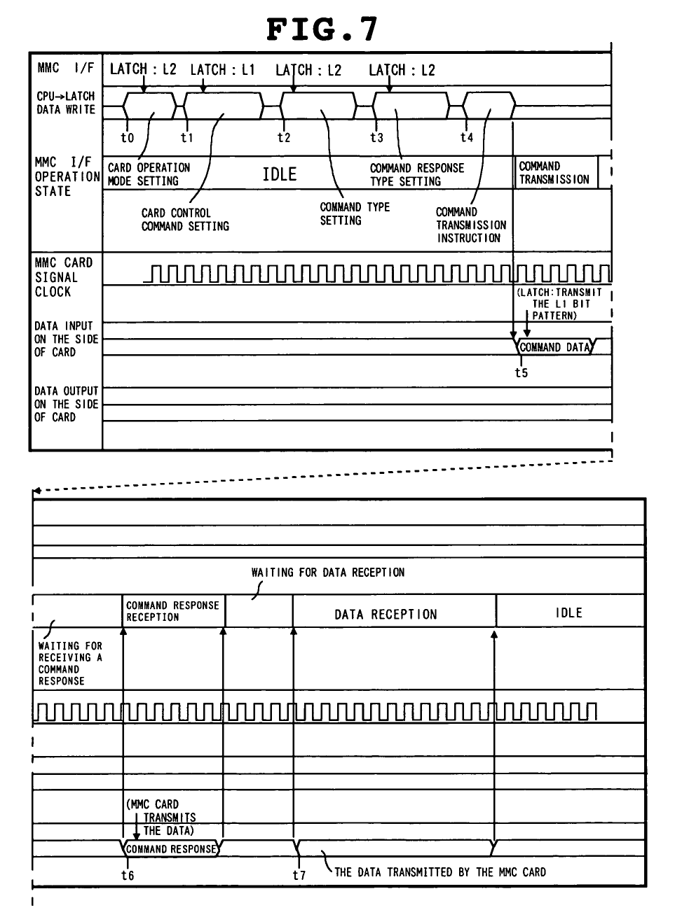

The classification of the operations according to the card control command, which can be represented by a combination of the command operation type information and the command response type information, can be schematically shown in FIG. 5. Namely, the operations are classified into a first command format (CMD) requiring no command response and no data transfer, a second command format (CMD+RES) not requiring a data transfer but requiring a command response, another third command format (CMD+RES (busy)) not requiring a data transfer but requiring a specified command response (rewrite busy), a fourth command format (CMD+RES+Read Data, single) requiring a command response and a single data block read, a fifth command format (CMD+RES+Read Data, multiple) requiring a command response and a multiple data block read, a sixth command format (CMD+RES+Read Data, stream) requiring a command response and a stream data read, a seventh command format (CMD+RES+Write Data, single) requiring a command response and a single data block write, an eighth command format (CMD+RES+Write Data, multiple) requiring a command response and a multiple data block write, a ninth command format (CMD+RES+Write Data, stream) requiring a command response and a stream data block write, and a tenth command format (CMD(stop)) for performing a specified operation (stop of the multiple data block access and the stream data access) without requiring a command response and a data transfer.

Some control operations by the MMCIF 3 will be described here. FIG. 6 shows an operation sequence of the command transmission and command response reception. The operation sequence corresponds to the second command format (CMD+RES). In FIG. 6, the CPU 2 sets the card operation mode information in the mode register MDR (time t0), sets the card control command in the command register CMDR (time t1), sets the command operation type in the command type register CTR (time t2), and sets the command response type in the command response register RTR (time t3). In this figure, L2 is the generic designation of the second latch means (MDR, CTR, RTR), and L1 means the command register CMDR. Thereafter, when the CPU 2 sets the enable bit in the command start register (time t4), the MMCIF 3 transmits the card control command in the command register CMDR (time t5). The MMC card 6 receives this, performs the internal processing specified by the received command, and returns the internal status to the MMCIF 3 as a command response (time t6).

FIG. 7 shows the operation sequence of the command transmission, command response reception, and data read access. This operation sequence corresponds to the fourth command format (CMD+RES+Read Data, single). In FIG. 7, the CPU 2 sets the card operation mode information (time t0), the card control command (time t1), the command operation type (time t2), the command response type (time t3), and the enable bit in the command start register (time t4), in the same way as mentioned above. Thus, the MMCIF 3 transmits the card control command in the command register CMDR (time t5), and in reply to this, the MMC card 6 returns the internal status to the MMCIF 3 as a command response (time t6). The data read from the MMC card 6 is supplied to the MMCIF 3 (time t7). The read address is specified by the contents of the argument portion of the card control command.

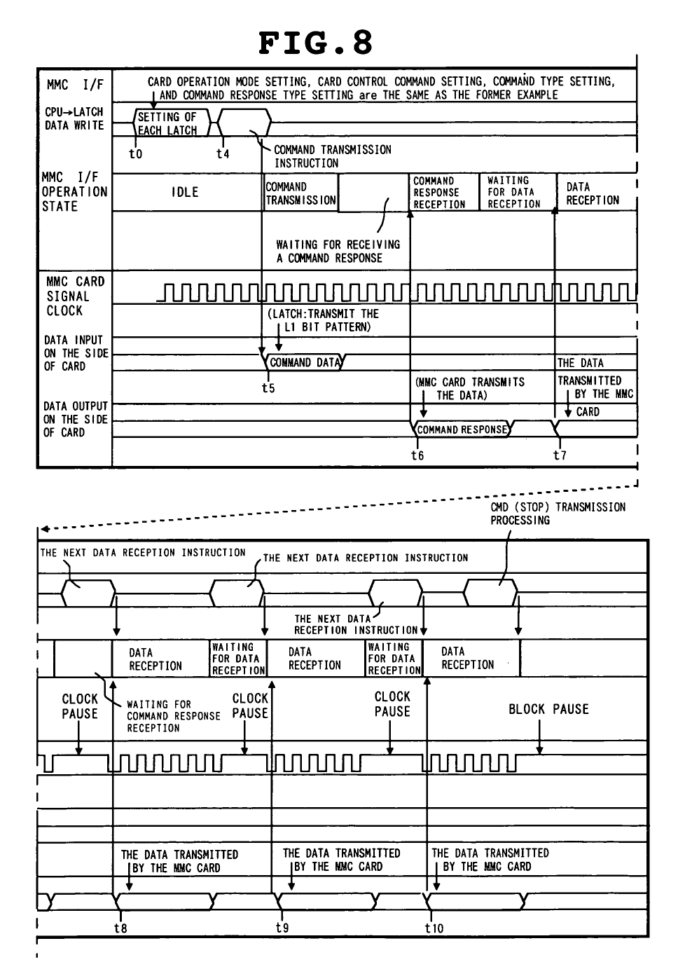

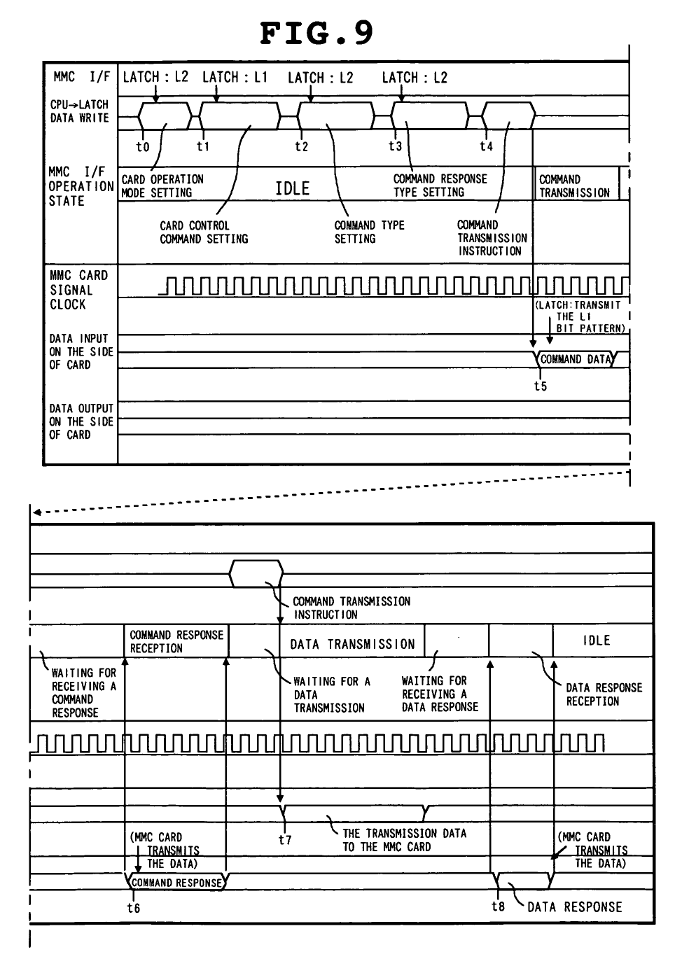

FIG. 8 shows the operation sequence of the command transmission, command response reception, and multiple data read access. This operation sequence corresponds to the fifth command format (CMD+RES+Read Data, multiple). In FIG. 8, in the same way as mentioned above, after setting the card operation mode information, the card control command, the command operation type, and the command response type, at time t0 and later, the CPU 2 sets the enable bit in the command start register (time t4). Thus, the MMCIF 3 transmits the card control command in the command register CMDR (time t5), and in reply to this, the MMC card 6 returns the internal status to the MMCIF 3 as a command response (time t6). Then, the data first read from the MMC card is supplied to the MMCIF 3 (time t7). The following read data is supplied to the MMCIF 3 in reply to the next data receiving instruction (time t8, t9, and t10), until transmission of the tenth command format (CMD (stop)). The read start address of the read data is specified by the contents of the argument portion of the card control command.

FIG. 9 shows the operation sequence of the command transmission, command response reception, and write access. This operation sequence corresponds to the seventh command format (CMD+RES+Write Data, single). In FIG. 9, in the same way as mentioned above, the CPU 2 sets the card operation mode information (time t0), the card control command (time t1), the command operation type (time t2), the command response type (time t3), and the enable bit in the command start register (time t4). Thus, the MMCIF 3 transmits the card control command in the command register CMDR (time t5), and in reply to this, the MMC card 6 returns the internal status to the MMCIF 3 as a command response (time t6). The MMCIF 3 transmits the write data according to the command transmission instruction, and upon receipt of this, the MMC card 6 writes the above write data (time t7). At last, as the data response, the MMC card 6 performs the CRC check on the write data and returns the above result to the MMCIF 3 (time t8). The write address of the write data is specified by the contents of the argument portion of the card control command.

The above-mentioned classification of the card control commands, as shown in FIG. 5, according to the command operation type information and the command response type information, conforms to the command specification of the MMC card which has been already formulated. All the commands formulated by the MMC association correspond to some of the above classification of FIG. 5. It is also possible to define a command function which has not been formulated, depending on the combination of the command operation type information and the command response type information or the setting contents. For example, assume that the command for controlling the multiple access operation is not formulated in the SPI mode. When the command function of the multiple block data access is afterward added to the command specification in the SPI mode or it is adopted as a user-unique command, if only a combination of the command operation type information and the command response type information is newly defined, depending on the added command function, the same command function can be added to the MMCIF 3. When a control function in reply to the new command is thus added to the MMCIF 3, a command code on the specification assigned to the specification-added command function will be used in the card control command for making the MMC card 6 process the above function.

It will be described further in details. For example, assume that the command of the command number CMD 21 has not been formulated on the specification of the MMC card. Assume that a new command is added as the command number CMD 21 afterward, according to the specification change. In this case, the interface control function corresponding to the added command function is defined as the setting information of the registers MDR, CTR, and RTR, and the code of the value 21 will be used as the command index in the command portion, in the card control command of the command number CMD 21 to be set in the register CMDR correspondingly. When the specification of the command function of the command number CMD 17 is changed, if its change is within the range changeable by the set values of the registers CTR and RTR, it is possible to cope with the above change by changing the setting information of the registers CTR and RTR corresponding to the card control command of the command number CMF 17.

Thus, when the addition or the change occurs in the command specification defined in the MMC card 6, a card control command using the added or changed command code may be added or the corresponding card control command may be changed, in order to cope with the command transmission to the MMC card 6. The control information of the card operation mode, the command operation type, and the command response type may be modified in accordance with the addition or the change of the function or the operation of the MMC card according to the added or changed command code, so as to cope with the interface control operation with the MMC card 6 according to the operation sequencer 9. Thus, it is possible to cope with the addition/change of the interface specification more easily than in the case of performing the interface control by directly decoding the command transmitted to the MMC card 6, and it is possible to cope with the addition/change of the interface specification without increasing the circuit size.

Here, notice is taken of the operation program of the CPU 2 for operating the MMCIF 3 with the information set in the registers CMDR, MDR, CTR, and RTR. The above register setting is performed by the CPU 2's execution of the operation program. At this time, the card control command set in the command register CMDR and the card operation mode, the command operation type, and the command response type respectively set in the registers MDR, CTR, and RTR, have to correspond to each other. In short, the command number of the command portion included in the card control command and the information of the command operation type and command response type have to be set in the register CMDR and the registers MDR, CTR, and RTR, in a way of corresponding to each other in point of function. All the demands may be satisfied by the CPU 2 in a program description. In this case, it will be a large burden in creating the software.

As illustrated in FIG. 1, a data table 20 with the correspondence among the command number, the command operation type, and the command response type defined there is prepared, a card control command is described in the operation program 21 run by the CPU 2 in order to control the operation of the MMCIF 3, but the information of its command operation type and command response type is not directly described in the program. Instead, the command number described in the card control command is searched for as the retrieval key, from the data table 20, and the information of the command operation type and the command response type obtained by the above retrieval is used so as to set the registers CTR and RTR. Thus, the labor of the software manufacturing can be decreased.

When the manufacturing maker of the data processor 1 provides the information of the data table 20 as the data library on the Internet, the burden of a user of the data processor 1 can be further decreased. The data table 20 may be formed in RAM or ROM of the other chip than that of the data processor 1. Alternatively, a data table 22 may be formed in the on-chip nonvolatile memory 5. The data tables 20 and 21 may be rewritten every time the command specification of the MMC card 6 has a change or addition, and when rewriting the tables through downloading the data from the data library on the Internet, the command specification changing and command adding processing can be extremely efficient and convenient.

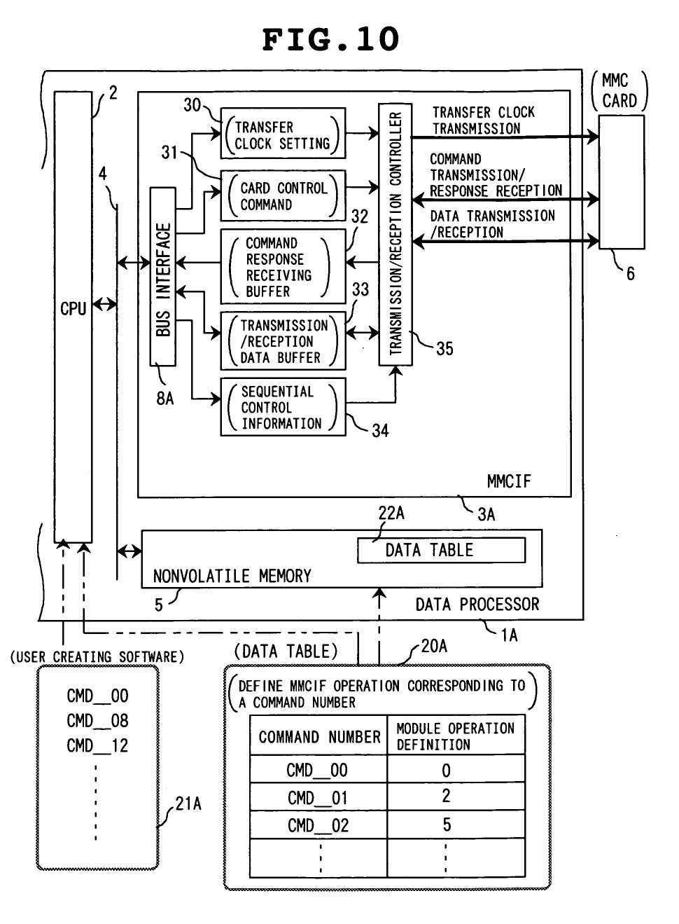

FIG. 10 shows a second embodiment of the data processor according to the invention. The data processor 1A shown in this figure comprises the CPU 2 and the MMCIF 3A similarly to the above. The MMCIF 3A has a clock setting register 30 and a command register 31 for setting the first control information for controlling the operation of the MMC card 6 to be connected to the MMCIF 3A as the first latch means. In the clock setting register 30, the number of clock pulses is set by the CPU 2, and in the command register 31, the card control command is set by the CPU 2. A card control command is given to the MMC card 6 through a transmission/reception controller 35, as for the interface operation with the MMC card 6. The interface of the data transmission and reception with the MMC card 6 which is given the card control command and operated is performed through a transmission/reception data buffer 33, and the command response is received through a command response receiving buffer 32. The transmission/reception controller 35 performs the above data transmission and reception and a receiving control of the command response, according to the sequential control information set in a sequential control register 34 as the second latch means which is given the second control information by the CPU 2. Here, the sequential control information means the program control information for realizing the control sequence in the sequence of the operations like the control information for transmission of a card control command, the control information for reception of a command response, and the control information of the data transmission and reception. The transmission/reception controller 35 decodes the sequential control information given in the time series, controls the interface with the MMC card 6 by using the registers 30 and 31 and the buffers 32 and 33, and each number of the operation cycles of each sequential operation is defined by the number of the clock pulses set in the clock setting register 30. After transmitting the card control command set in the register 31 to the MMC card 6, the CPU 2 sequentially updates the sequential control information to be set in the sequential control register 34, hence to sequentially control the interface operation with the MMC card 6 operating based on the card control command. The sequence control of the interface operation highly depends on the operation program 21A run by the CPU 2, increasing the load in the CPU 2 but increasing the flexibility of the control operation. Thanks to this, it is possible to cope with the addition and the change of the interface specification represented by the command specification of the MMC card 6 at ease without an increase in the circuit size.

The sequence control information corresponding to the command number may be obtained by referring to the data table 20A. Rewriting of the data table 20A can do with the addition and change of the command specification similarly to the above. The data table 20A may be held in an off-chip ROM or RAM in the data processor 1A or the data table 22A may be formed in a nonvolatile memory 5 of the data processor 1A.

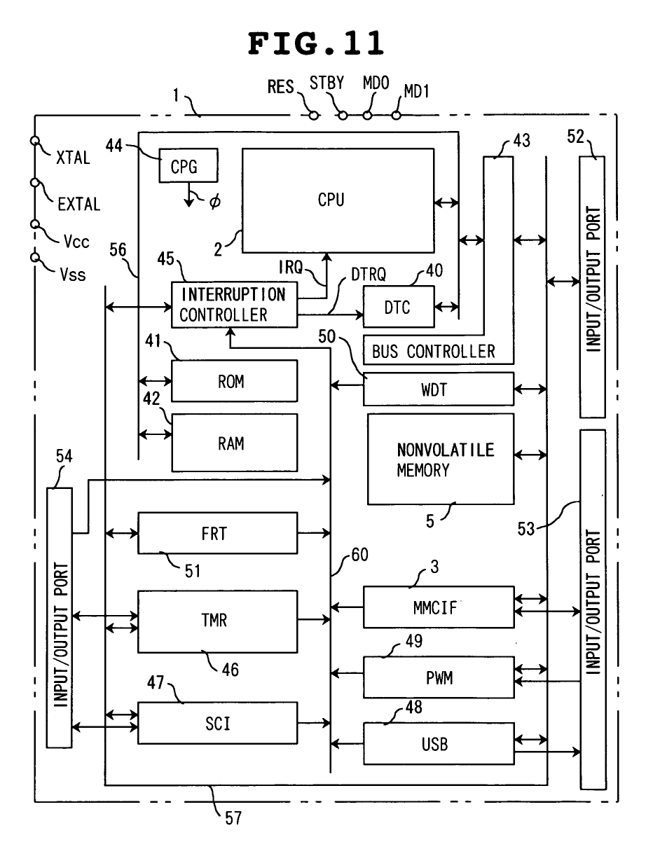

FIG. 11 shows the whole of the data processor 1. In FIG. 11, the data processor 1 comprises a central processing unit (CPU) 2, a data transfer controller (DTC) 40, a read only memory (ROM) 41 that is a program memory for storing the processing program of the CPU 2, a random access memory (RAM) 42 used for the working region of the CPU 2 and for temporarily storing the data, the nonvolatile memory 5, a bus controller 43, a clock generator (CPG) 44, an interruption controller 45, a timer counter (TMR) 46, a serial communication interface controller (SCI) 47, a universal serial bus controller (USB) 48, the MMCIF 3, a pulse wise modulator (PWM) 49, a watchdog timer (WDT) 50, a free running timer (FRT) 51, and input/output ports 52 to 54. The MMCIF 3A may be used in place of the MMCIF 3. The CPU 2, the DTC 40, the ROM 41, the RAM 42, and the bus controller 43 are connected to the CPU bus 56. The CPU bus 56 interfaces with a peripheral bus 57 through the bus controller 43, and as the peripheral circuits, the interruption controller 45, the TMR 46, the SCI 47, the USB 48, the MMCIF 3, the PWM 49, and the WDT 50 are connected to the peripheral bus 57. Each of the CPU bus 56 and the peripheral bus 57 includes the data bus, the address bus, and the control signal bus, and correspond to the above-mentioned bus 4. The peripheral bus 57 interfaces with an external bus (not illustrated) through the input/output port 52, and the CPU bus 56 interfaces with the peripheral bus 57 through the controller 43 and further interfaces with the external through the input/output port 52. The input/output ports 53 and 54 work as an external interface buffer for the peripheral circuit.

The bus master module in the data processor 1 is the CPU 2 and the DTC 40. The CPU 2 includes an instruction controller for fetching an instruction from the ROM 41, for example, and decoding the same instruction and an executing unit for performing the calculation by using the general register or the arithmetic logic operator according to the instruction decoded result by the instruction controller. The data transfer control condition of the DTC 40 is set in the RAM 42 previously by the CPU 2, the corresponding data transfer control condition is loaded into the DTC 40 from the RAM 42 when the FRT 51 issues the data transfer request, and the DTC 40 performs the data transfer control according to loaded transfer control condition.

The bus controller 43 arbitrates in the competition for the right of bus between the CPU 2 and the DTC 40 that are the bus master modules and the external bus master. The arbitration logic is based on the adjustment control based on, for example, according to the priority. As the result of the arbitration, the bus master module to which the bus right is given outputs a bus command and the bus controller 43 controls the bus based on the bus command. The bus controller 43 supplies an address signal and an access strobe signal to the outside through the input/output port 52 when the address signal supplied by the bus master module means an external address space of the data processor 1.

An internal interrupting signal supplied from the peripheral circuit such as the FRT 51 connected to the peripheral bus 57 and an external interrupting signal received from the outside through the input/output port 54 are supplied to the interruption controller 45. The internal interrupting signal and the external interrupting signal are generically referred to as 60. The interruption controller 45 accepts an interruption request through the priority control and the mask control on the input interrupting signal. Upon receipt of the interruption, the interruption controller 45 supplies an interruption request signal IRQ to the CPU 2 or a DTC starting request signal DTRQ to the DTC 40, depending on the type of the interruption request signal.

Upon receipt of the interruption request signal IRQ, the CPU 2 interrupts the executing processing to branch to a predetermined processing routine according to the cause of the interruption. In the end of the branched processing routine, a return instruction is executed, and the interrupted processing can be resumed by the execution of this instruction.

A data transfer control enable register (DTCER) is provided for every DTC channel in the interruption controller 45, hence to enable the setting of the permission/prohibition of the DTC start as for several kinds of interruption causes. When it is permitted, the corresponding DTC starting request signal DTRQ of the DTC channel is activated according to the occurrence of the corresponding interruption cause, and when it is prohibited, the interruption request signal IRQ is activated according to the occurrence of the corresponding interruption cause. The cause of interruption enabling the activation of the DTC 40 is not restricted especially, but it is caused by an input capture interruption and a conveyor match in the FRT 51 and a transmission finish interruption and a reception finish interruption in SCI 47. The DTC vector number and the corresponding vector address are determined in every interruption cause enabling the activation of the DTC 40. The head address of the region on the RAM for storing the data transfer control condition activated by the corresponding DTC starting request is stored in the vector address. When the DTC starting request signal DTRQ is given from the interruption controller 45 to the DTC 40, the corresponding DTC vector is supplied to the DTC 40. The DTC 40 loads the data transfer control condition on the RAM 42 indicated by the DTC vector, into the transfer control register and controls the data transfer according to the loaded transfer control condition.

The data processor 1 has external terminals of ground level (Vss), power voltage level (Vcc), and the like, as the battery terminal, and further the respective terminals of a reset input (RES), stand-by (input STBY), mode control input (MD0, MD1), and clock input (EXTAL, XTAL) as the exclusive control terminal.

The CPG 44 generates a system clock signal φ based on a quartz oscillator connected to the terminal EXTAL and XTAL or an external clock signal supplied to the EXTAL terminal, although it is not especially restricted.

When the reset signal RES is given to the data processor 1, the on-chip circuit module of the CPU 2 or the like is turned into a reset state. When the reset state by the reset signal RES is released, the CPU 2 reads the instruction from a predetermined start address and starts running the program. According to this, for example, it fetches the data from the RAM 15, calculates the fetched data, and based on the result, performs the input/output operation of the signal with the outside by using the FRT 51, and controls various units.

The same structure as the addition and change of the interface specification described in FIG. 1 can be adopted also in the USB 48.

As mentioned above, although the invention made by the inventor has been described concretely according to the embodiments, the invention is not restricted to the above embodiments, but it is needless to say that various modifications can be made without departing from its sprit.

For example, the control information for the first and second latch means may be set not only directly by the CPU but also by the data transfer control device such as a direct memory access controller or a data transfer controller for transferring data based on the control of the CPU.

The second control information for the interface control is not restricted to the classification information such as the command operation type information and the command response type information but it may be properly changed depending on the function of the peripheral circuit.

The data processor is not restricted to a single chip type but it may be a multi chip type. Further, the interface controller is not restricted to the interface controller of the MMC card, but it can be used for the interface controller of the flash memory card, the interface controller of the USB, and the like.

A circuit such as the operation control sequencer for receiving the second control information such as the command operation type and command response type information and performing the interface control may be based on a hard wired logic or a program control logic.

The data table which can show the relationship among the command number, the command type, and the command response type may be formed in an on-chip mask ROM. The data library to provide the entry of the data table is not restricted to that one accessible on the Internet but it may be provided in the form of the storing medium including a CD-ROM and a flexible disk.

The effects obtained by the representative one according to the invention disclosed in this specification will be briefly described as follows.

Since the interface operation of the data processor can be defined separately according to the first control information for controlling the operation of the interface-controlled device and the second control information for controlling the interface operation with the above interface-controlled device in a correspondence way with each other, when any addition or change occurs in the command defined for the interface-controlled device, the added or changed command code may be newly added as one of the first control information or the corresponding first control information may be changed in point of the transmission of a command to the interface-controlled device. In point of the interface control operation of the interface controller itself, the second control information may be changed so as to control the interface-controlled device corresponding to the addition or change of its function or operation being caused by added or changed command code. Thus, according to the invention, it becomes easier to cope with the addition/change of the interface specification, than in the structure of directly decoding a command to transmit to the interface-controlled device, for interface control. Further, it is possible to cope with the addition/change of the interface specification without increasing the circuit size.

Since the interface control is performed by using the data table in a correspondence relationship between the first control information and the second control information, the load on the software of the CPU can be decreased.

According to the addition or change of the first control information, the data table may be amended in a way of adding a correspondence between the first control information concerned with the addition and the second control information to the data table and changing the correspondence between the first control information concerned with the change and the second control information. According to the update method of this data table, it is possible to cope with a change such as the command specification with less trouble.

What is claimed is:

1. A data processor having a central processing unit and an interface controller controlled by the central processing unit, wherein
the interface controller comprises first latch means for receiving first control information for controlling an operation of an interface-controlled device connected to the interface controller according to a control of the central processing unit and second latch means for receiving second control information for controlling an interface operation with the interface-controlled device according to a control of the central processing unit.

2. The data processor according to claim 1, wherein
the interface controller comprises control means for transmitting the first control information after the first and second control information is latched by the first and second latch means.

3. The data processor according to claim 1, wherein
the second control information includes first type specification information for classifying an operation form of the interface-controlled device into a basic form according to the first control information and second type specification information for classifying variations of the classified operation forms.

4. The data processor according to claim 3, wherein
the interface controller comprises control means for controlling the interface operation after decoding the first and second type specification information.

5. The data processor according to claim 3, wherein
the first type specification information includes information of several bits indicating the basic form about presence of a data transfer, direction of a data transfer, and a data transfer sequence.

6. The data processor according to claim 3, wherein
the second type specification information includes information of several bits specifying data amount of a response to a command.

7. The data processor according to claim 1, wherein
the second control information includes operation mode information for determining a connection terminal function with the interface-controlled device in a selectable way.

8. The data processor according to claim 1, further comprising
a nonvolatile storing device capable of storing a correspondence relationship between the first control information and the second control information in a way of being referred to by the central processing unit.

9. The data processor according to claim 8, wherein
the nonvolatile storing device is a flash memory rewritable through the central processing unit.

10. The data processor according to claim 9, which is formed on one semiconductor chip.

11. The data processor according to claim 1, wherein
the interface controller controls a nonvolatile memory card as the interface-controlled device.

12. The data processor according to claim 11, wherein
the nonvolatile memory card is a multimedia card.

13. A data processor having a central processing unit and an interface controller controlled by the central processing unit, wherein
the interface controller comprises first latch means for receiving first control information for controlling an operation of an interface-controlled device connected to the interface controller according to a control of the central processing unit and second latch means for receiving second control information for controlling an interface operation with the interface-controlled device according to a control of the central processing unit, and
after transmitting the first control information supplied to the first latch means, to the interface-controlled device, the central processing unit sequentially updates the second control information to be supplied to the second latch means, hence to sequentially control an interface operation with the interface-controlled device operating according to the first control information.

14. A method for updating a data table, in a data processing system having: an interface controller including first latch means for receiving first control information for controlling an operation of an interface-controlled device connected to the interface controller and second latch means for receiving second control information for controlling an interface operation with the interface-controlled device; and the data table which is referred to for controlling the interface controller, for holding a correspondence relationship between the first control information and the second control information in a rewritable way, the above method comprising
a step of, in accordance with an addition or a change of the first control information, adding a correspondence between the first control information concerned with the addition and the second control information to the data table and amending a correspondence between the first control information concerned with the change and the second control information in the data table.

15. The data table update method according to claim 14, wherein
the data table is a rewritable nonvolatile storing device.
